(19) United States
(12) Patent Application Publication
(10) Pub. No.: US 2009/0212959 A1
(43) Pub. Date: Aug. 27, 2009

(54) Home safety detector with communication system

(76) Inventor: Edward H. Suber, III, Akron, OH (US)

Correspondence Address: Edward Suber III;Carey Suber, 1445 Virginia Ave., Akron, OH, 44306, US

(21) Appl. No.: 12/072,176

(22) Filed: Feb. 25, 2008

(51) Int. Cl. G08B 21/14

(52) U.S. Cl. 340/603; 340/540

(57) ABSTRACT

The present invention relates generally to a home safety device such as a gas or carbon monoxide detector, and more specifically, to a smoke and fire detector. The present invention will include a built in communication system capable of dialing outbound phone calls to alert an outside party of an emergency. The user will be able to pre-record a message to be played when the outbound phone call is connected to the programmed phone number. The present invention will also be programmable so that the user can set the amount of time that the alarm will emit before the phone call is made to the programmed number.

### BACKGROUND OF THE INVENTION

1. Field of the Invention

The present invention relates generally to a home safety device such as a gas or carbon monoxide detector, and more specifically, to a smoke and fire detector with a built in communication system capable of making phone calls.

2. Description of the Related Art

Currently, there exists a wide variety of consumer products specifically designed for safety in the home. One of the most popular safety devices is a smoke detector. A smoke detector is a safety device that detects airborne smoke and issues an audible alarm, thereby alerting nearby people to the danger of fire. A household smoke detector will typically be mounted in a dish shaped plastic enclosure about 25 mm thick and 150 mm in diameter. Because smoke rises, most detectors are mounted on the ceiling or on the walls near the ceiling. To avoid the nuisance of false alarms, most smoke detectors are mounted away from the kitchen. To increase the chance of awaking sleeping occupants most homes have at least one smoke detector near any bedroom, ideally in a hallway as well as near the bathroom. Most smoke detectors are powered by one or more batteries but some can be connected to household wiring. Often most smoke detectors that are hooked up to household wiring also have battery backup in case of a failure in the wiring or loss of power. These detectors are usually more efficient and user-friendly because the user does not have to maintain the changing of batteries as much as in a battery operated detector. Most smoke detectors work either by optical detection (photoelectric) or by physical process (ionization), but some of them use both detection methods to increase sensitivity to smoke. The present invention enhances the performance of the current household detectors such as gas, carbon monoxide and smoke detectors. When the present invention detects any of the said elements and begins to issue its alarm, it will also use its built in communication system to call the user's local fire department or any other programmed phone number. The present invention may also include a built in message system for the user to prerecord a message to be given to the call recipient when requesting for assistance. There are many home safety devices on the market today that can be linked to a home's protection alarm system, thus making the user responsible for paying a monthly fee to keep the service. The present invention eliminates the need for a paid subscription to a monitoring service. The present invention can be purchased at any local retailer selling the product and will be easily installed by the user, not requiring a paid professional installer. The present invention adds extra protection to the home by providing a way to quickly call for assistance in the event of a home disaster, thus decreasing the amount of damage to the home caused by smoke or fire. There have been many concerns about the effectiveness of the alerting function in awakening sleeping individuals and also in high risk groups such as the elderly and those with hearing loss. The present invention will also be added protection to a home in the case of children being home alone and not sure what to do during the event of tragedy. The present invention will also add extra protection to the home during times of vacation or any other time the house in not occupied by the user.

Consequently, a need has been felt for providing a home safety detector with built in communication system that makes an outgoing call to a preprogrammed phone number in time of emergency. There also exists a need for a safety detector that greatly simplifies the use of operation by providing a messaging system which allows the user to prerecord information such as a request for assistance, special directions such as address, size of household, contact information, etc.

### SUMMARY OF THE INVENTION

It is an object of the present invention to provide an apparatus and method for detection of a hazardous condition such as but not limited to harmful gases or smoke caused by fires, which said device may then dial a preprogrammed phone number to an emergency response team when the apparatus' alarm is triggered.

It is a feature of the present invention that the apparatus may be powered by battery operation or wired to a home's main electrical system.

Another feature of the present invention is an audible signaling device for emitting an audible tone or signal to alert user in the local vicinity that a hazard has been detected.

It is a feature of the present invention that the user may set a time limit that the safety device would have to emit the alarm signal before dialing out the programmed phone number, thus eliminating false alarms.

A further feature of the present invention is to provide an improved safety device that allows a user to pre-record a message to be played at the time of the call made to the programmed phone number(s).

Briefly described according to one embodiment of the present invention, a user can program a home safety detecting device to dial an emergency phone number at the time of the detection of a hazard such as but not limited to a fire. The user can also set a programmed time limit that the home safety detecting device would have to emit the alarm before it would dial the programmed phone number. In accordance with a preferred embodiment of the present invention, the user will be able to pre-record a message to be played at the time the device makes the connected phone call to the programmed phone number.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1a is a flowchart of a home safety detector with communication system detecting no hazardous element.

FIG. 1b is a flowchart of a home safety detector with communication system detecting hazardous element.

FIG. 2 is a simplified block diagram of the home safety detector in accordance to the present invention.

FIG. 3 is a diagram showing the components of a home safety detector in accordance to the present invention.

### DESCRIPTION OF THE PREFERRED EMBODIMENTS

The best mode for carrying out the invention is presented in terms of its preferred embodiment, herein described and depicted within the Figures.

### 1. Detailed Description of the Figures

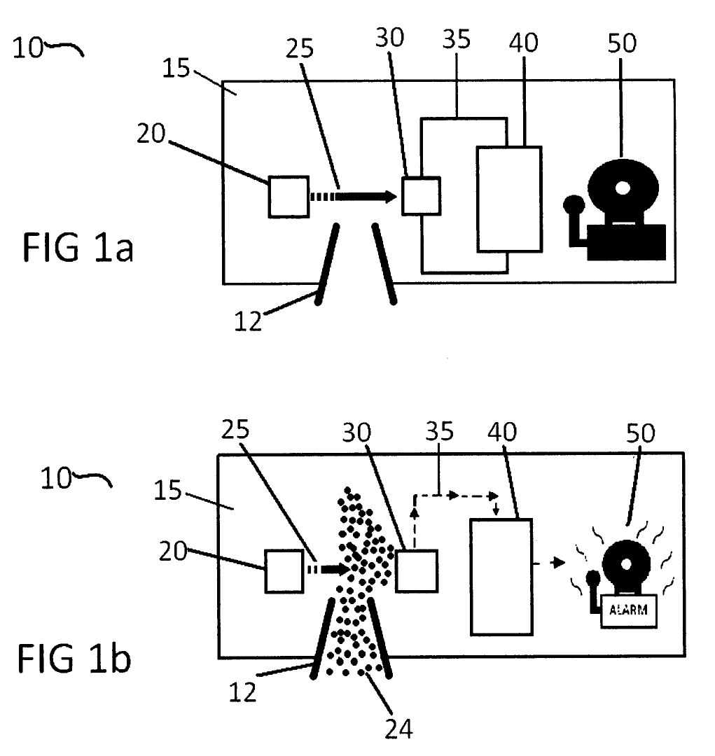

Referring to FIG. 1a, a home safety detector with communication is shown 10, in accordance with the preferred embodiment, shows one way the apparatus may detect for hazardous materials. The home safety detector with communication system 10 may contain an optical chamber 12 to allow the entrance of smoke into a light chamber 15. The home safety detector with communication system 10 may also contain a light-emitting diode or LED 20. An invisible infrared light beam 25 will be emitted and shot across the chamber 15 from the LED 20 to a photocell 30. The photocell 30 is an electrical light detector that generates an electric current 35 for as long as light falls on it. Normally when there is no smoke present, the light beam 25 shoots constantly between the LED 20 and the photocell 30. An electric circuit 40 detects the electric current 35 created from the presence of the light beam 25 and no alarm is triggered. The home safety detector with communication system 10 may also contain a lens (not shown) to collimate the light beam 25 into the path of the photocell 30.

Referring now to FIG. 1b, smoke particles 24 enter light chamber 15 by means of the optical chamber 12, thus blocking the contact of the light beam 25 to the photocell 30. Because no light is falling on the photocell 30, the electric current 35 is interrupted and the electric circuit 40 triggers the alarm 50 to sound. When the lens (not shown) is used to direct the path of the light beam 25 into the photocell 30, the alarm 50 will be triggered by the increased amount of light beam 25 being detected.

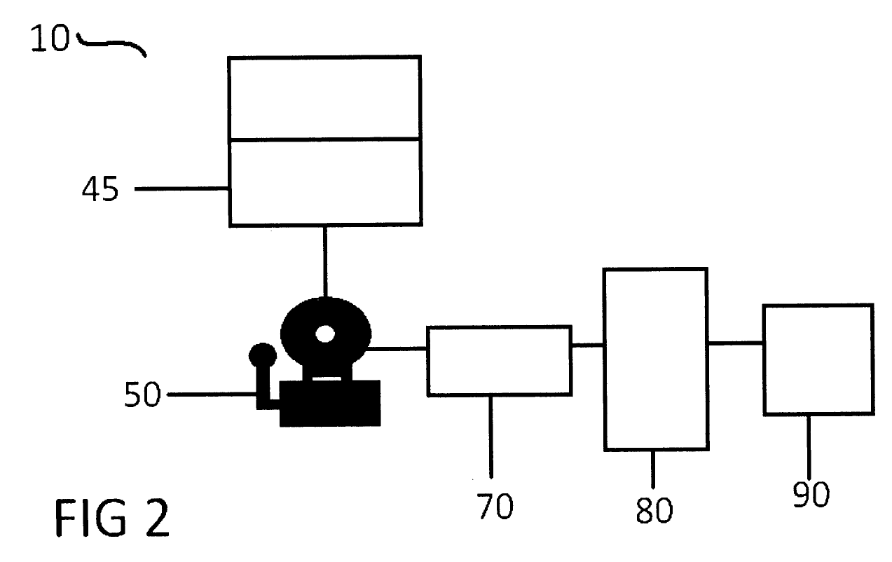

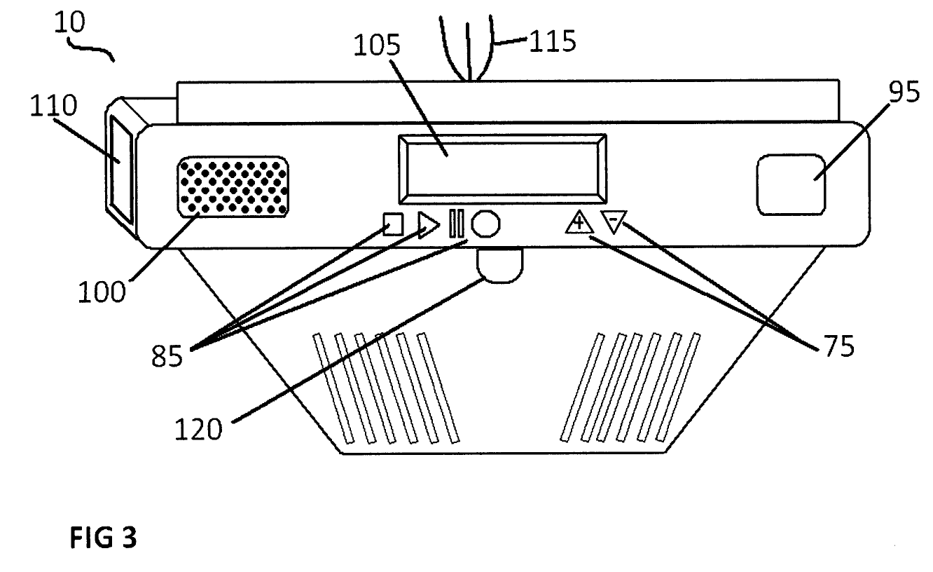

Referring to FIG. 2, the home safety detector with communication system 10 contains a timer 70 and an outgoing message storage assembly 80. The detector with communication system 10 may also include a carbon monoxide detector 45 that is linked to the alarm 50. Once the alarm 50 is triggered by either detection device and becomes audible, the timer 70 begins to count the amount of time elapsed from the emitting of the alarm 50. When the timer 70 reaches the programmed amount of time that the user has set, the timer 70 will then trigger the outgoing message storage assembly 80. The outgoing message storage assembly 80 will dial and call a phone number that the user has previously programmed. When the call is connected to the receiving party, the outgoing message storage assembly 80 will also play a recording that the user has previously saved by means of an internal storage device 90. Referring to FIG. 3, the home safety detector with communication system 10 is powered by a battery power, which is usually a 9-volt battery located in battery door 110, or by a 120-volt house current 115 which is also backed up by battery power in 110. The LED indicator 120 illuminates to show that the apparatus is working properly and detecting for hazardous elements. The control buttons 85 and an external microphone 95 are used to record the message to be played by the outgoing message storage assembly 80 (shown in FIG. 2). An external speaker 100 is used to listen to the playback of the recorded message saved onto the internal storage device 90 (shown in FIG. 2) of the outgoing message storage assembly 80 (shown in FIG. 2). Control buttons 75 may be used to program the timer 70 (shown in FIG. 2) and to program the phone number(s) to be dialed for the emergency call out by the outgoing message storage assembly 80 (shown in FIG. 2). An LCD screen 105 may be used to display settings when the user is programming the home safety detector with communication system 10.

### 2. Operation of the Preferred Embodiment

To use the present invention, the user first powers the unit by installing the proper batteries or hard wiring the unit into the home's main electrical system. The user may use the control buttons 75 and the LCD screen 105 to program the dial-out phone number and the length of time for the alarm to be emitted before the call is made out. The user may then use the control buttons 85 and the external microphone 95 to record a message onto the outgoing message storage assembly 80. The user may play back the recorded message to check for accuracy by means of the external speaker 100. The user then installs the home safety detector with communication system 10 in the proper location(s) in the home. The home safety detector with communication system 10 is now ready to detect hazardous elements that could be emitted into the air of the home. If the detector is triggered by an element such as but not limited to smoke or carbon monoxide, the alarm 50 will emit an audible sound to alert persons in the home. The timer 70 will then begin to count until it reaches the time set by the user. When this time is reached, the outgoing message storage assembly 80 will make a phone call to the programmed phone number. Once the call is connected, the recorded message set by the user on the internal storage device 90 will begin to play. This will allow an emergency response team to be notified and dispatched to the home quicker, thus allowing more lives to be saved and less damage to homes.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

Having thus described the invention what is claimed as new and desired to be secured by Letters Patent is as follows:

1. A home safety detector with communication system apparatus comprising:
an audible alarm system;
an outgoing message storage assembly;

2. The system of claim 1, wherein the outgoing message storage assembly further comprises an output device to make an outgoing phone call(s) to a programmed phone number(s) and an internal memory storage device to store recorded messages.

3. The system of claim 1, further comprising a detection device to detect the presence of hazardous materials in the air.

4. The system of claim 1, further comprising an LCD screen, an external speaker and a microphone.

5. The system of claim 1, further comprising a timer to monitor the elapsed time of the emitted alarm being sounded.

6. The system of claim 4, further comprising an external speaker for the emitting of the alarm and for playback of recorded messages on the outgoing message storage assembly.
